(19) United States
(12) Patent Application Publication
(10) Pub. No.: US 2021/0185925 A1
(43) Pub. Date: Jun. 24, 2021

(54) AEROPONICS SYSTEM

(71) Applicant: AIRPONIX LTD, London Surrey (GB)

(72) Inventors: Michael RUGGIER, London (GB); John Russell PREWER, London (GB)

(73) Assignees: AIRPONIX LTD, London, Surrey (GB); AIRPONIX LTD, London, Surrey (GB)

(21) Appl. No.: 16/076,244

(22) PCT Filed: Feb. 7, 2017
(86) PCT No.: PCT/GB2017/050300

§ 371 Date: Aug. 7, 2018

Related U.S. Application Data
(60) Provisional application No. 62/292,323, filed on Feb. 7, 2016.

(30) Foreign Application Priority Data
Apr. 1, 2016 (GB) 1605611.1

(51) Int. Cl. A01D 46/26; A01G 31/02

(52) U.S. Cl. CPC A01D 46/26; A01D 2046/262; A01G 31/02

(57) ABSTRACT

The present disclosure relates to the use of an aeroponic propagator for the cultivation of plants. The aeroponic propagator of the present disclosure may be a human intervention free system. The aeroponic propagator of the present disclosure may allow the total spectrum of all stages of plant growth from seedling to harvest and multi-cropping per system with minimum human intervention. The aeroponic propagator comprises a self-harvesting system for collecting produce from cultivated plants, wherein the self-harvesting system is configures to collect produce that has detached from the cultivated plants.

The present invention relates to an aeroponics system, in particular an aeroponic propagator for the cultivation of plants.

Aeroponics is a development of hydroponic methods. Hydroponics is the technique of growing plants in water-based solutions of nutrient salts. Although known over 100 years ago it was not used extensively until the Second World War, when it was used to provide troops with green vegetables in parts of the world where normal methods of cultivation were impractical. Hydroponic technology has since been matured and is widely used in many countries and has proved to be the most economical production method in greenhouses. Still initial costs are substantial, and rockwool/glasswool substrates cause vectors for spreading diseases, and create large heaps of incombustible waste after each crop and a large recurring cost. These drawbacks feed a continuous search for better technology.

A hydroponic system known as the nutrient film technique (NFT) was developed during the 1960s at the UK's Glasshouse Crops Research Institute by Dr. Alan Cooper. Although widely acclaimed as a significant advance in hydroponic growth techniques it has a number of drawbacks. The main ones being that—though simple in concept—it tends to be expensive to install and often has been difficult to operate profitably because of disease and nutrient control problems. In spite of these limitations, NFT's appeal to growers is such that it has been used in more than 70 countries.

Aeroponics has gained much publicity over recent years. It is defined by the International Society for Soil-less Culture as “A system where roots are continuously or discontinuously in an environment saturated with fine drops (a mist or aerosol) of nutrient solution”. The method requires no substrate and entails growing plants with their roots suspended in a chamber (the root chamber), with the roots periodically atomised with a fine mist or fog of nutrients, a process which uses significantly less water than alternative growing techniques. Since their inception some 30 years ago, aeroponic techniques have proved very successful for propagation and are widely used in laboratory studies of plant physiology, but have yet to prove themselves on a commercial scale. Aeroponics could also have applications in crisis situations because an aeroponics system can be designed to work in the event of such things as reduced solar radiation levels (e.g. due to high levels of fine volcanic ash particles in the atmosphere) or floods.

However, the main limitations associated with commercial aeroponic systems are high equipment costs, infrastructure (e.g. greenhouses) costs and low equipment reliability.

According to one aspect of the present invention there is provided an aeroponic propagator for the cultivation of plants, the aeroponic propagator comprising a self-harvesting system for collecting produce from cultivated plants wherein the self-harvesting system is configured to collect produce that has detached from the cultivated plants.

The self-harvesting system may be configured to promote detachment of produce from the cultivated plants.

The aeroponic propagator may comprise a surface which is arranged beneath the produce of the cultivated plants.

The surface may be inclined such that detached produce which falls on to the surface is encouraged to roll or slide down the incline.

The surface may be a resilient surface configured to reduce or prevent damage caused to produce on impact with the surface.

The surface may have an arc shape formed along the length of the surface, and optionally comprises a drainage outlet in the surface.

The surface may be configured to undulate to move produce along the surface.

The surface may be a base, which may optionally be situated above the ground, preferably approximately 40-50 cm above the ground.

The aeroponic propagator may further comprise a collector configured to receive produce detached from the cultivated plants.

The aeroponic propagator may further comprise a structure on which the plants are grown, and wherein the self harvesting system comprises a vibration mechanism configured to detach produce from the cultivated plants.

The vibration mechanism may be configured to shake the structure to promote detachment of produce from the cultivated plants.

The vibration mechanism may comprise an oscillating and/or reciprocating device, wherein the frequency of oscillation and/or reciprocation can be controlled to control vibration of the structure.

The aeroponic propagator may further comprise a blowing device configured to blow gas onto the structure to promote detachment of produce from the cultivated plants, optionally wherein the blowing device is a variable speed device.

The aeroponic propagator may further comprise a blowing device configured to blow gas onto the plant to promote detachment of produce from the cultivated plants, optionally wherein the blowing device is a variable speed device.

The aeroponic propagator may further comprise a fogging system for supplying a fog to at least one seed and/or at least a part of a plant in the aeroponic propagator and a reservoir of liquid for use by the fogging system, wherein the liquid comprises a hormone and/or chemical to promote detachment of produce from cultivated plants.

The aeroponic propagator may further comprise a fogging system for supplying a fog to at least part of the aeroponic propagator, and a reservoir of liquid for use by the fogging system, wherein the fogging system is configured to electrically charge the fog to promote sterilization of the at least part of the aeroponic propagator.

The fogging system may be configured to supply droplets having a diameter of less than or equal to approximately 50 nm, or preferably less than or equal to approximately 25 nm.

The aeroponic propagator may further comprise a cutting mechanism comprising at least one blade, wherein the cutting mechanism is configured to move the blade relative to the cultivated plants to detach a part of the plant and/or the produce from the cultivated plant.

The aeroponic propagator may further comprise a device to blow dry gas into the aeroponic propagator to promote detachment of produce from cultivated plants, and/or to reduce or prevent decay and/or germination of the produce after detachment, and/or at an appropriate time to promote pollination of plants.

According to an aspect of the invention there is provided for collecting produce from cultivated plants, the method comprising collecting produce which has detached from the cultivated plants using a self-harvesting system.

According to another aspect of the present invention there is provided an aeroponic propagator for the cultivation of plants, the propagator comprising a plurality of sealed tubes, each tube containing seeds to be grown in the propagator, wherein the sealed tubes have a mechanism configured to selectively rupture at least one tube to expose the seeds contained in the tube.

Each tube may have a corresponding cord, and the cord can be used to selectively rupture the at least one tube.

The aeroponic propagator may further comprise a fogging system for supplying a fog to at least one exposed seed and/or at least an exposed part of a plant in the aeroponic propagator.

The fogging system may be configured to supply fog to at least one of the sealed tubes.

The tube may be made from a material with low water vapour permeability.

The aeroponic propagator may further comprise a porous layer positioned inside the sealed tube, the porous layer being configured to hold the seeds.

The porous layer may be formed of dead, dried roots of aeroponically grown plants.

According to an aspect of the invention, there is provided a method for cultivating plants, the method comprising providing a plurality of sealed tubes, each tube containing seeds to be grown in an aeroponic propagator, and selectively rupturing at least one tube to expose the seeds contained in the tube.

The present invention will be described with reference to exemplary embodiments and the accompanying Figures in which:

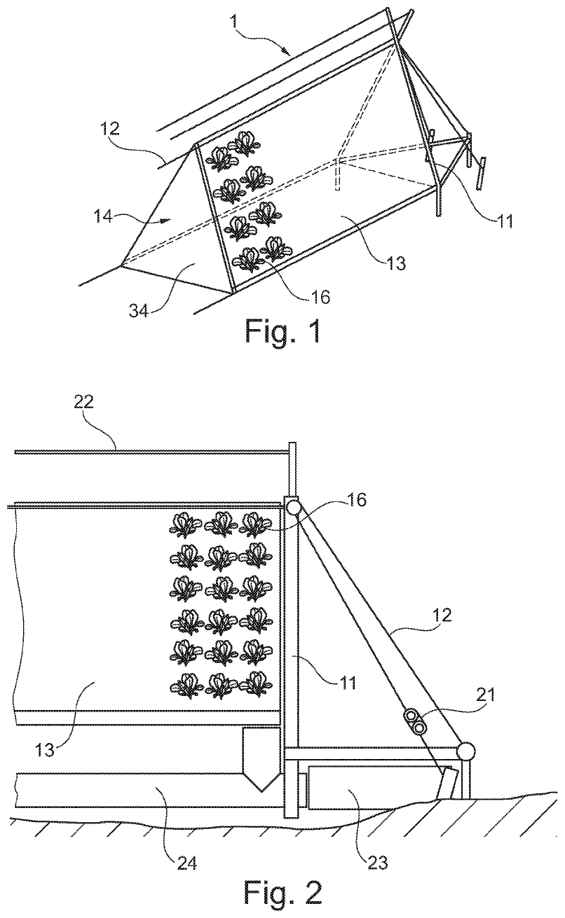

FIG. 1 is a schematic perspective view of an aeroponic propagator which may be used with an embodiment of the present invention;

FIG. 2 is a schematic side view of the end of an aeroponic propagator which may be used with an embodiment of the present invention;

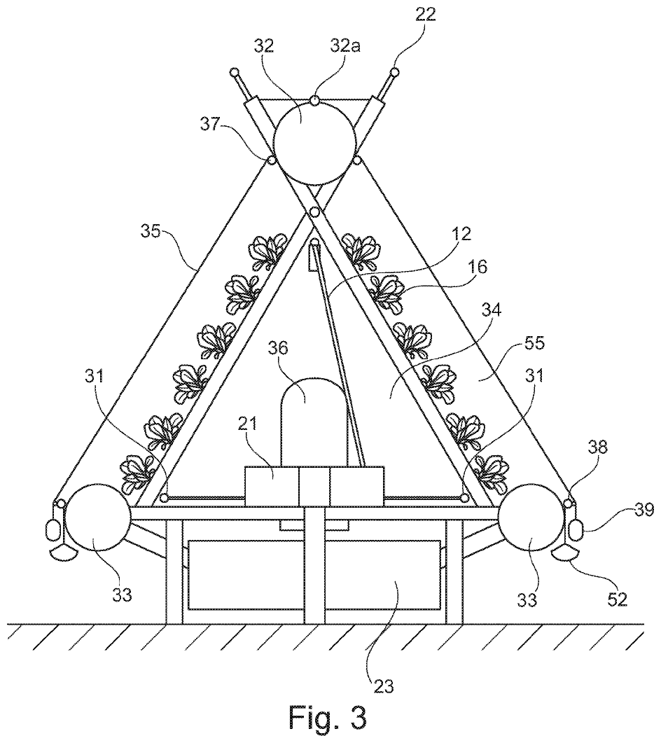

FIG. 3 is a schematic view of the end of an aeroponic propagator which may be used with an embodiment of the present invention;

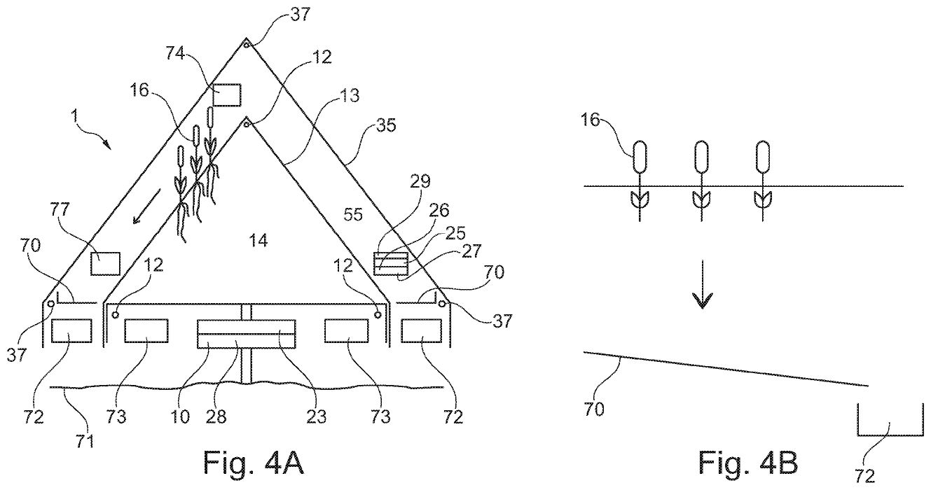

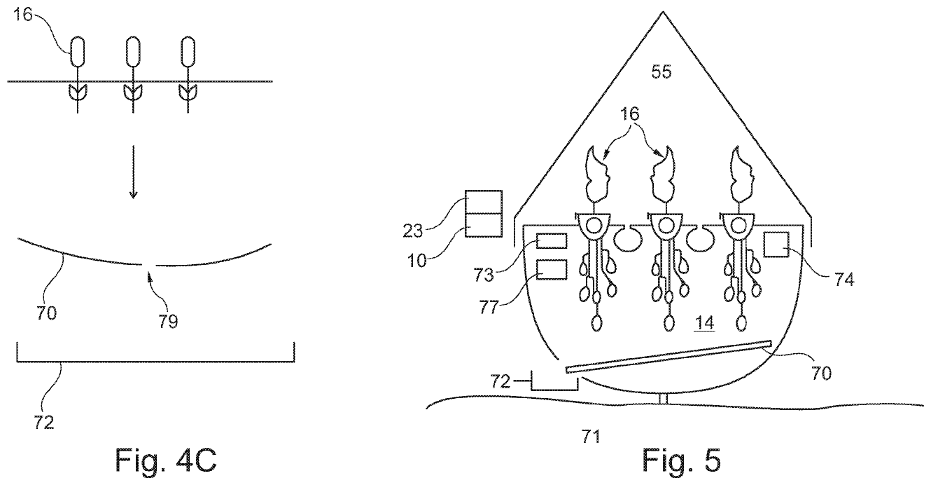

FIG. 4A is a schematic end view of an aeroponic propagator in accordance with a first embodiment of the invention;

FIGS. 4B and 4C are side views of variations of the aeroponic propagator such as that for growing grain crops depicted in FIG. 4A;

FIG. 5 is a schematic view of an aeroponic propagator in accordance with the first embodiment such as for the growing of potatoes;

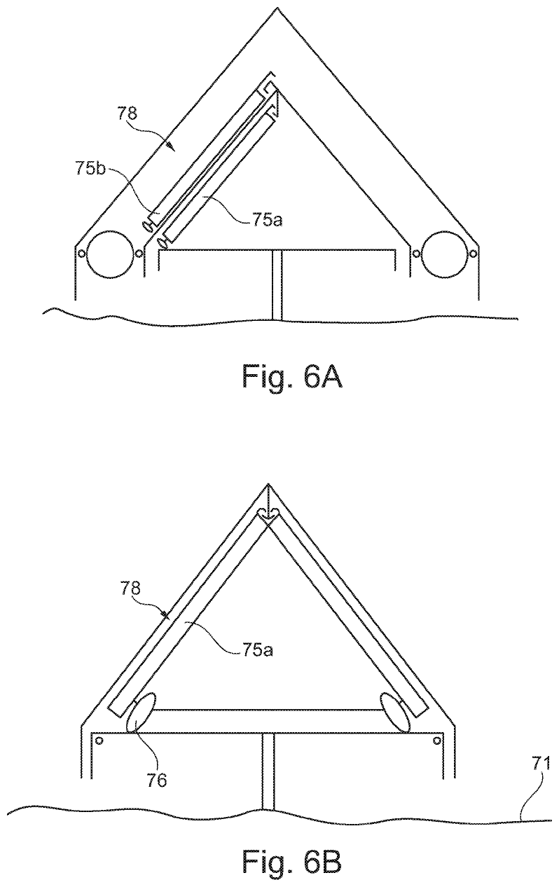

FIG. 6A is a schematic end view of an aeroponic propagator comprising a cutting mechanism in accordance with the first embodiment;

FIG. 6B is a more detailed version of an example of the cutting mechanism depicted in FIG. 6A;

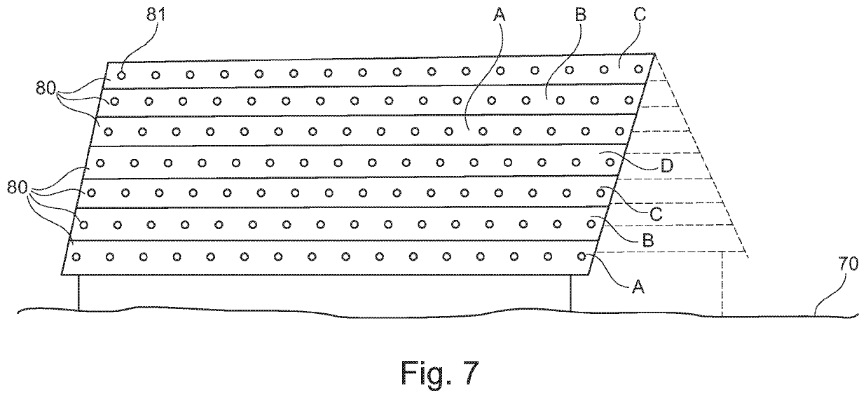

FIG. 7 is a schematic side view of sealed tubes within an aeroponic propagator 1 in accordance with a second embodiment of the invention;

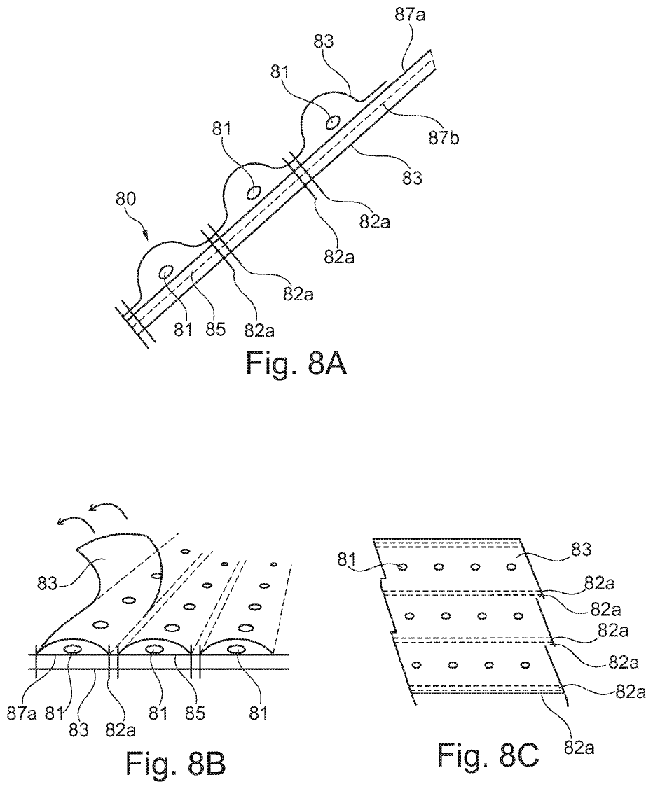

FIGS. 8A, 8B and 8C depict close up versions of the second embodiment depicted in FIG. 7 from different angles.

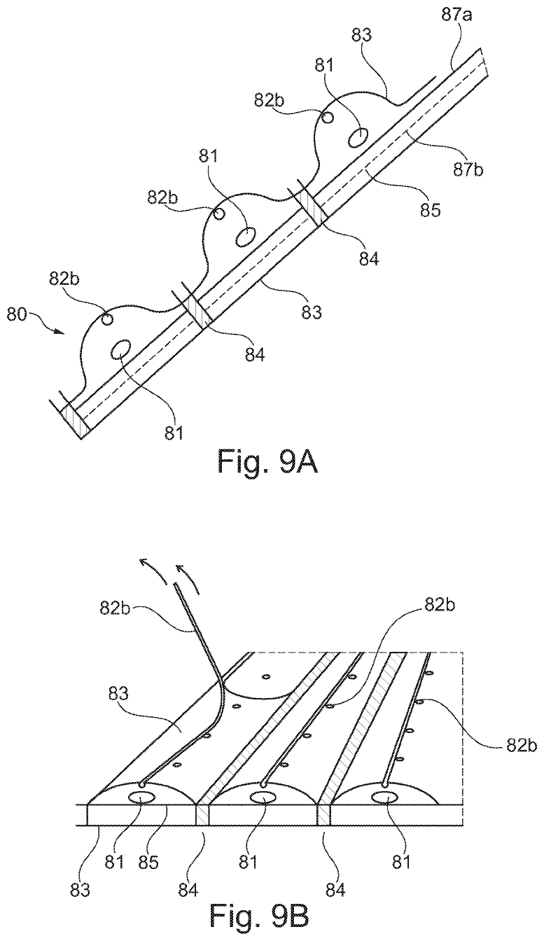

FIGS. 9A and 9B depict variations of the close-ups depicted in FIGS. 8A and 8B respectively; and

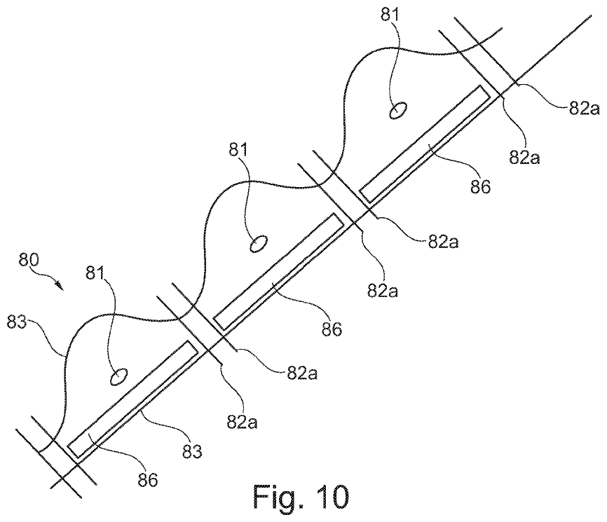

FIG. 10 depicts a variation of the close-ups depicted in FIG. 8A;

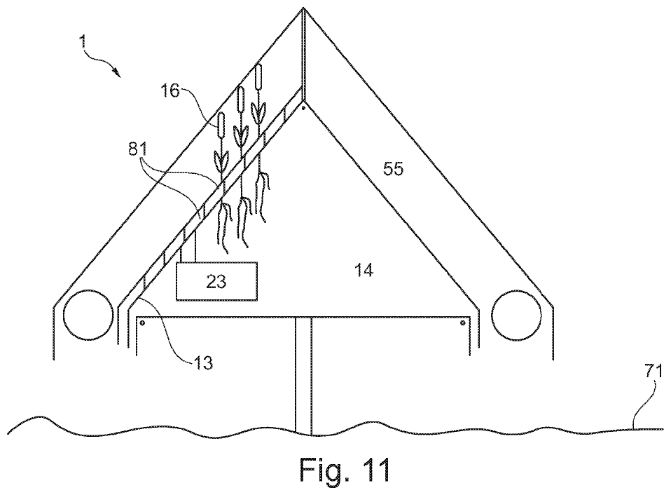

FIG. 11 depicts a schematic end view of an aeroponic propagator in accordance with the second embodiment.

In the Figures, like parts are identified by like reference numbers. The features shown in the figures are not necessarily to scale and the size or arrangements depicted are not limiting. It will be understood that the figures include optional features which are not essential to the invention. Furthermore, not all of the features of the aeroponic propagator are depicted in each figure and the figures may only show a few of the components relevant for a describing a particular feature.

FIGS. 1-3 show various views of an aeroponic system, which is an example of an aeroponic propagator 1. The aeroponic propagator 1 is used for the cultivation of plants when in use. It is noted that the term plants is used as a general term to cover different species of plant and at least a part of a plant, for example the roots and/or the foliage. The term plant may be used interchangeably with the term crop. Seeds may be used instead of plants and any of the embodiments described below may be used with seeds, thus the seeds may be germinated to form plants which are cultivated.

The system may be the same as described in WO 2012/156710 A1. The system may include the same features as in any of the embodiments of WO 2012/156710 A1 and may have any of the variations disclosed therein. For example, the aeroponic propagator 1 may be as depicted in FIGS. 1 to 3 which are described in detail in WO 2012/156710 A1. As such, WO 2012/156710 A1 is incorporated by reference herein. As described, the aeroponic propagator 1 may comprise a frame optionally comprising end frames 11. The frame may be covered by at least one sheet 13. The sheet 13 may define a space used as a root chamber 14. Plants 16 may be grown on the sheet 13 wherein the roots of the plant 16 may be located below the sheet 13 in the root chamber 14 and the foliage of the plant 16 may be located above the sheets 13. The aeroponic propagator 1 may comprise an arrangement of lines, such as line 12 which is used to hold the frame in position. The line 12 may further comprise at least one winch, such as winch 21 to keep the line 12 taught to provide support to the structure. Further lines may be provided depending on the structure of the aeroponic propagator 1, for example line 37 in FIG. 3. The aeroponic propagator 1 may additionally comprise a closer panel 34 as depicted in FIG. 1 to close the root chamber 14.

As depicted in FIG. 2, the aeroponic propagator 1 may comprise a fogging system 23 configured to generate a fog, and further may comprise a return tube 24 to extract fluid from an area of the aeroponic propagator, for example the root chamber 14. As also depicted in FIG. 2, the aeroponic propagator 1 may comprise power cables 22 to provide power to at least one component of the aeroponic propagator 1. For example, the power cables 22 may provide electricity to the fogging system 23.

FIG. 3 depicts a further variation described in greater detail in WO 2012/156710. The aeroponic propagator 1 in FIG. 3 may be similar to the aeroponic propagator shown in FIG. 2, except the aeroponic propagator 1 in FIG. 3 also comprises a foliage chamber 55 in which the foliage of the plants 16 may be located as the plants 16 are cultivated. The aeroponic propagator 1 may comprises an outer sheet 35 which substantially defines the outer portion of the foliage chamber 55. The outer sheet 35 may be an outer sheet of the aeroponic propagator 1. The aeroponic propagator 1 may comprise a vent flap 36 which can be opened to allow fluid (e.g. condensate) to pass into or out of the root chamber 14. Similarly a further vent flap (not shown) may be provided to allow fluid to pass into or out of the foliage chamber 55. Vent seals 32 and 33 may be provided, which may for example be inflatable vent seals, to control the passage of fluid into and out of the aeroponic propagator 1, or the root chamber 14 and/or the foliage chamber 55. The vent seals can attach to the propagator 1 via any suitable connecting mechanism, for example vent seal 32 may be connected via connecting mechanism 32a in FIG. 3. Further lines, 37 and 38 may be provided as in FIG. 3.

The aeroponic structure 1 may be supported in various means, for example, through the use of supporting members 31. The sheet 13 may be secured to the frame and/or lines e.g. line 38, via any appropriate method, such as strong acting clips similar to large plastics clothes pegs or by using the deadweight of water, such as in water-filled tubes 39 in FIG. 3 for example. Additionally, the aeroponic propagator may comprise gutters 52 as a means for collecting water, from condensation on the inside of the sheet 13 as well as rain water and dew. The water may be collected and recycled.

It is to be understood that these figures depict example structures of the aeroponic propagator 1. The aeroponic propagator 1 may have a substantially different shape, for example, it may be a cuboid, e.g. a rectangle, a cylinder, a sphere, a spherical cone or any other suitable shape. The foliage chamber 55 and the root chamber 14 may form part of the aeroponic propagator in various different ways not limited to the examples shown in the drawings. For example, the root chamber may be a bottom portion of the aeroponic propagator, irrespective of shape, and may take up any appropriate portion of the overall aeroponic propagator 1 depending on the size of the aeroponic propagator 1. The root chamber 14 and/or the foliage chamber 55 may comprise structures and or supports for the roots and/or foliage respectively as required. As described below, the root chamber 14 and the foliage chamber 55 each allow root and/or plants and/or produce to be dried, before the roots and/or plants and/or produce are trimmed. Therefore, no separate desiccation chamber is required (although one could be included if desired).

In a first embodiment, an aeroponic propagator 1 is provided, the aeroponic propagator 1 comprising a self harvesting system for collecting produce from cultivated plants. FIGS. 4A, 4B and 4C are examples of aeroponic propagators 1 in accordance with the first embodiment. The self harvesting system is configured to collect produce that has detached from the cultivated plant 16, for example, as depicted in FIGS. 4A, 4B and 4C. In other words, the first embodiment provides a system for gathering produce from plants 16 which does not require manual detachment of the individual produce of the plants 16. The produce may detach from the cultivated plants due to the effects of gravity and/or due to methods for promoting produce detachment. For example, this can apply to tomatoes in the foliage chamber 55 or potatoes in the root chamber 14 or any other variety of fruit or vegetables which may be used in either chamber. In other words, the first embodiment provides a system which automates the collection of produce detached from cultivated plants 16. Being configured to collect the produce may mean that the aeroponic propagator 1 is configured to gather the produce and/or direct the produce to somewhere it can be held. As an example only, the aeroponic propagator 1 depicted in FIGS. 4A, 4B and 4C may be used for growing grain crops.

The aeroponic propagator 1 being self-harvesting may mean that the self-harvesting components are part of a human intervention free system. This means that the aeroponic propagator 1 may be able to grow and cultivate plants throughout their whole life cycle, for example, including self-planting/seeding (an example of which is described in the second embodiment below), germination, growing, pollinating, drying (if required), self-harvesting, collecting and cropping and removing of the waste. In other words, the aeroponic propagator 1 may allow the total spectrum of all stages of plant growth from seeding to harvest and multi-cropping per system with minimum human intervention. Additionally, the aeroponic propagator 1 having the features described herein may allow this cycle may be repeated a number of times per year for a number of years. Therefore, it might be a self-contained system that only requires minimal services, for example, provided at one or both ends of the aeroponic propagator 1.

The aeroponic propagator is intended to be used under the effect of gravity. In other words, the aeroponic propagator is intended to be used on Earth. The methods using the aeroponic propagator may be described as gravity-based methods.

The self-harvesting system may be particularly useful when harvesting from an aeroponic propagator 1 when installed on steeply sloping terrain or where large numbers of plants 16 are involved as the automated system does not require manual collection of the produce. Such a system also increases the efficiency of harvesting the plants 16 because the produce does not have to be manually collected which is likely to be more time consuming. In addition very little, if any, of the produce will be wasted e.g. by falling to the ground and being lost. When plants are grown in an aeroponic propagator 1, it may reduce the accessibility of the produce due to the produce being located within the aeroponic propagator 1. Thus, providing a harvesting system configured to collect the produce may make the produce more accessible and easier to obtain.

The aeroponic propagator 1 may be configured to collect produce in a variety of different ways. For example, the aeroponic propagator 1 may comprise a surface 70 arranged beneath the cultivated plants 16, or more particularly, beneath the produce of the cultivated plants 16. As shown in FIGS. 4A, 4B and 4C, the surface 70 does not need to be directly below the plant 16 (i.e. directly below the plant 16 and aligned in plan view), it is sufficient that the surface 70 is provided lower than the plant 16 in the vertical direction. The surface 70 may be beneficial in aiding collection of the produce which detaches and falls onto the surface 70, e.g. due to the effect of gravity. The produce may be collected by a user directly from the surface 70. The surface 70 may be provided in the foliage chamber 55 as depicted in FIGS. 4A, 4B and 4C. Additionally or alternatively, the surface 70 may be provided in the root chamber 14 as depicted in FIG. 5. The surface 70 will be most usefully located in the same chamber as the produce from the plant 16. The surface 70 may be a resilient surface. Thus, the surface 70 may be configured to reduce or prevent damage caused to produce on impact with the surface. The aeroponic propagator may further comprise a collector 72, and optionally, the produce may be further directed to a collector 72 by the surface 70, as depicted in FIGS. 4A, 4B, 4C and 5.

Although not a requirement, the surface 70 may be inclined such that detached produce which falls onto the surface 70 is encouraged to roll or slide down the incline. In other words, the surface 70 may be configured to transport the produce by using gravity to move the produce. It is noted that as an addition or as an alternative, the surface 70 could comprise some sort of mechanical system for transporting the produce, for example a brush and/or an blowing device aimed at the produce to move the produce along the surface 70, and optionally, to a collector 72.

As depicted in FIG. 4A, the surface 70 may be situated above the ground 71. This is beneficial because it allows room for incline of the surface 70 if required as well as positioning of the collector 72 if in use. Additionally, providing a surface 70 above the ground 71 allows the surface 70 to be positioned closer to the produce. This may protect the produce from simply falling, sliding or rolling onto the ground 71 which could damage or contaminate some of the produce. The surface 70 by being above ground makes the growth chambers difficult for rodents and other pests (e.g. ants) to attack and penetrate them.

Providing the surface 70 at an incline means that the incline can be selected or controlled. Thus the incline may be chosen to allow the produce to roll or slide gently towards a collection point, such as the collector 72. This can prevent the produce from moving or falling rapidly which could damage the produce. As depicted in FIG. 4B, the surface 70 may be inclined along a length of the aeroponic propagator 1 such that produce rolls or slides into a collector 72 which may be placed at a relevant end of the aeroponic propagator 1. FIG. 4B may be a side view of the aeroponic propagator in FIG. 4A. All the features of FIG. 4A are not shown in FIG. 4B, but the features in FIG. 4B may be used with the other features of FIG. 4A already described. The surface may be inclined such that one end of the surface 70 is higher than the other. Alternatively, although not shown, the surface 70 may be at the same horizontal level along the length of the aeroponic propagator 1, and may instead be inclined in a direction perpendicular to the length, i.e. one side of the surface 70 may be higher than the other. For example, the surface 70 depicted in FIG. 4A could be at an angle to the horizontal. If this was the case, it may be beneficial to have the collector 72 configured along the length of the surface 70 at the lower side of the surface 70 as depicted in FIG. 4C. FIG. 4C may be a side view of the aeroponic propagator in FIG. 4A. All the features of FIG. 4A are not shown in FIG. 4C, but the features in FIG. 4C may be used with the other features of FIG. 4A already described. The collector 72 may be placed at an end or along the length of the aeroponic propagator 1 as appropriate.

The surface 70 may have an arc shape, or more particularly, a catenary shape, formed along the length of the surface as depicted in FIG. 4C, i.e. the surface 70 may be curved along it's length. This means that the surface 70 may be configured to allow unused nutrients and water to pool at the lowest point (i.e. the base) of the arc (or catenary) shape, which may optionally be at a mid point where along the length of the surface 70. The surface 70 may optionally comprise a drainage outlet 79 in the surface 70. The drainage outlet 79 may simply be an opening located in the surface 70 to allow liquid to pass through. Nutrient and liquid which pools at the base of the arc (or catenary) shape of the surface 70 can escape through the drainage outlet 79 and may optionally be recycled, e.g. by pumping the liquid to a nutrient tank for recycling in the fogging system 23 described below.

The surface 70 may be configured to undulate to move produce along the surface. The surface 70 may be moved using the vibration mechanism 73. The vibration mechanism 73 may be attached to the overall aeroponic propagator 1 or the surface 70. The vibration mechanism 73 may be configured to promote a peristaltic-type movement effect in the surface 70 capable of moving fallen produce along the undulating surface to an end or a side of the aeroponic propagator 1 to be collected. For example, the vibration mechanism 73 may be configured to promote a peristaltic-type movement effect in the surface 70 capable of shaking grain along the surface. The vibration mechanism 73 may optionally comprise a motor used to undulate the surface.

The surface 70 described in any of these variations may be a base, which may optionally be situated above the ground. For example, the base 70 may preferably be situated approximately 40-50 cm above the ground, and preferably approximately 45 cm above the ground 71.

The collector 72 may be configured to receive produce detached from the cultivated plants. The collector 72 may be any appropriate vessel which may be used to collect the produce. For example, the collector 72 may be a bucket, bag (e.g. net bag) or tray capable of holding the produce. Ideally, the collector 72 should be of an appropriate size to collect a substantial amount of the produce expected from any particular harvest of plant 16 being cultivated by the aeroponic propagator 1. The collector 72 may be removable from the aeroponic propagator 1, i.e. the collector 72 may be removed and replaced or returned easily to allow produce to be removed from the collector 72.

The aeroponic propagator 1 may optionally be tilted along the length of the propagator and/or sideways. This may be done temporarily. The aeroponic propagator 1 may be tilted by a user or by an actuator (not shown). The aeroponic propagator 1 may be tilted to facilitate the collection of produce from a particular side of the propagator, e.g. from the bottom end of the aeroponic propagator. The aeroponic propagator 1 may be tilted to aid in the collection of produce, e.g. potatoes, or other produce such as dry grain which can easily slide down over the surface/base 70.

The self-harvesting system may be configured to promote detachment of produce from the cultivated plants 16. The self-harvesting system may have at least one apparatus or device configured to physically affect the plant 16 and/or the environment around the plant 16 in order to encourage the produce to detach from the plant 16. This may be done in various different ways as will be described in the examples below. Detachment of the produce may be promoted in order to more efficiently harvest/collect the produce. This provision may encourage produce which would otherwise remain attached to the plant to detach, thus allowing it to be collected. This may provide an improved system which increases the yield of the harvest and allows more products to be collected which might otherwise have been wasted.

In this embodiment, the aeroponic propagator 1 may comprise a structure, for example comprising the frame as described above. The structure may be formed using the lines as described above and may comprise lines 12 and/or lines 37 as depicted in FIG. 4A. For example, lines 12 may provide structural support for the root chamber 14 as depicted, and lines 37 may provide structural support for the foliage chamber 55 as depicted. The plants may be grown on the structure. For example, at least lines 12 and optionally the frame described above may form the structure using sheet 13, on which the plants 16 are grown. For example, the structure may hold sheet 13 in place, allowing the plants 16 to grow on the sheet 13. An outer structure may be formed using lines 37 and an outer sheet 35 may be provided to enclose the foliage chamber 55.

The outer sheet 35 may be a film, e.g. a plastic film, which is preferably transparent to let light into the aeroponic propagator 1 for photosynthesis in the plants. For example, the outer sheet 35 may be a polyethylene film. Alternatively, the outer sheet 35 may comprise an organic compound, such as cellulose, or more particularly, may be made of biodegradable cellophane. The outer sheet 35 may form a protective barrier around the plants, and may substantially enclose the plants within the aeroponic propagator 1. The aeroponic propagator 1 may comprise artificial lighting, e.g. using LEDs. Artificial lighting may be used when daylight length is insufficiently long for some types of crops in some parts of the world and/or when daylight levels are caused to fall below levels needed for photosynthesis to occur, e.g. due to a volcanic eruption.

It will be understood that the structure may be formed in a variety of ways, in a variety of shapes. However, it will be understood that the structure is a supporting structure to which the plant 16 may be physically connected. The structure may be considered as a simple frame to which the lines and/or sheets may be attached to support the plants 16. The structure may be a lightweight structure, which may be operating substantially under tension.

In an example, the self-harvesting system may comprise a vibration mechanism configured to detach produce from the cultivated plants. The vibration mechanism is an example of an apparatus or device configured to promote detachment of produce from the cultivated plants.

In an example, the vibration mechanism may be configured to shake the structure on which the plants 16 are grown in order to promote detachment of produce from the cultivated plants 16. The vibration mechanism may be configured to shake the whole aeroponic propagator 1, or a significant part of it. For example, the vibration mechanism may include a vibration device 73 as depicted in FIG. 4A. The vibration device 73 may be physically attached to the structure to shake it, for example, back and forth. The vibration generated by the vibration device 73 may be controlled depending on the particular plant 16 being cultivated. For example, the vibration device 73 may control the length of time for which the vibration device 73 shakes the structure. For example, this may be varied and may be as little as a few seconds up to approximately one minute, or even more. The length of time may be selected or varied depending on a variety of factors, including the type of produce being cultivated, the ripeness of the produce, the arrangement of the produce, the expected or actual number of items of produce and/or the shape and/or weight of the produce. Additionally or alternatively, the vibration device 73 may be controlled to vibrate at specified frequencies and/or amplitudes. The vibration device 73 may vibrate at a predetermined frequency and/or amplitude dependent on a variety of factors, including the type of produce being cultivated, the ripeness of the produce, the arrangement of the produce, the expected or actual number of items of produce, and/or the shape and/or weight of the produce. The frequency and/or amplitude of the vibration may be controlled to vary whilst in use or to be altered to a set value, for example depending on a known resonant frequency and/or amplitude which may most effectively promote detachment of the produce from the plant 16.

The vibration device 73 may be an oscillating and/or a reciprocating device. The oscillating and/or a reciprocating device may be controlled to oscillate and/or provide reciprocating motion to shake the structure. The frequency of oscillation and/or reciprocation may be controlled to control vibration of the structure as described above. For example, the oscillating and/or a reciprocating device may comprise off-centre rotating weight, or may be an oscillating linear motor, or may be a reciprocating engine or pump. As described above, the vibration device 73 may be controlled (i.e. varied or set at a predetermined value. As such the frequency/rotational speed can be controlled. Additionally or alternatively, the vibration mechanism may comprise external means to shake the aeroponic propagator 1 and/or the structure.

The aeroponic propagator 1 may comprise a blowing device 74, the blowing device 74 is depicted in FIG. 4A. The blowing device 74 may be provided in addition or as an alternative to the vibration device 73 also depicted in FIG. 4A. The blowing device 74 may be configured to blow gas on to the structure to shake it to promote detachment of the produce from the cultivated plants 16 (e.g. rice from the foliage or potatoes from the roots). Additionally or alternatively, the blowing device 74 may be configured to blow gas on the produce and/or plant 16. In other words, the blowing device 74 may be configured to direct gas towards the plant, or more specifically, towards the produce. The gas being blown on the produce and/or plant may promote detachment of the produce from the plant 16. The gas being blown on the produce and/or plant 16 may shake at least one of the produce and the plant 16 to detach the produce from the cultivated plant 16. The blowing device 74 may be configured to blow gas onto the produce and/or the plant and/or the structure, or the blowing device may comprise several separate devices to blow gas onto at least one of the produce and/or the plant and/or the structure.

The blowing device 74 may be controlled in a similar way to the vibration device 73 as described above. For example, the length of time the blowing device 74 is used for may be selected or varied depending on a variety of factors, including the type of produce being cultivated, the ripeness of the produce, the arrangement of the produce, the expected or actual number of items of produce, and/or the shape and/or weight of the produce. Additionally, the intensity of the gas blown by the blowing device, i.e. the gas flow rate leaving the blowing device or the speed at which a rotating fan is rotated may be controlled (i.e. selected or varied) depending on a variety of factors, including the type of produce being cultivated, the ripeness of the produce, the arrangement of the produce, the expected or actual number of items of produce, and/or the shape and/or weight of the produce. The blowing device may therefore be a variable speed blowing device.

At least the vibration mechanism and/or the blowing device 74 may beneficially enhance pollination due to the freeing of pollen when the plants 16 are moved as a result.

Additionally or alternatively, a fogging system 23 may be provided for supplying a fog to at least one seed and/or at least part of a plant 16 in the aeroponic propagator 1. A reservoir 10 may be provided, the reservoir 10 being a reservoir 10 of liquid 28 for use by the fogging system 23. The reservoir 10 may be any component capable of storing the liquid 28, i.e. holding it for the required period of time. The reservoir 10 may be in fluid communication with the fogging system 23, or may be a part of the fogging system 23 as depicted in FIG. 4A.

The liquid 28 may comprise a hormone and/or chemical to promote ripening and/or detachment of produce from the cultivated plants 16. The hormone may be referred to as a plant hormone. The chemical may be a biochemical. Using such a hormone and/or chemical may be beneficial because the hormone and/or chemical may be specifically chosen depending on the type of plant 16 being cultivated. For example, the liquid 28 may comprise ethylene gas to promote ripening of the produce and/or auxin and/or gibberellic acid to promote abscission of the produce. The liquid 28 may comprise a finely powdered dry material, such as biochar. Similarly, other solid particles such as rhizobia and/or N2-fixing bacteria and/or fungal spores can be included in the liquid 28, particularly when the liquid is supplied to roots. The fog comprising these components may travel long distances inside the aeroponic propagator, e.g. over approximately 30 metres, when supplied by the fog system 23.

The fogging system 23 may be controlled to alter the hormone and/or chemical provided, for example to provide a different hormone and/or chemical, or a different combination. Additionally, the amount of hormone and/or chemical may be controlled, as well as the rate at which it is supplied. Any or all of these factors may be varied/controlled depending on a variety of factors, including the type of produce being cultivated, the ripeness of the produce, the arrangement of the produce, the expected or actual number of items of produce, and/or the shape and/or weight of the produce.

Providing at least one hormone and/or chemical using a fogging system 23 may be beneficial because the fogging system 23 may provide accurate amounts and rates of the hormone and/or chemical. It will generally be well known how certain hormones and/or chemicals affect certain plants 16, thus, the use of a fogging system 23 to provide a hormone and/or chemical to the plant may be done with a high degree of accuracy. This may be done, for example, such that the harvest can be done at a desired time.

The aeroponic propagator 1 comprising the fogging system 23 allows plants to be foliar fed in rapidly moving currents of dense nutrient-containing liquid fog. The fogging system 23 may be configured to provide a fog wherein the droplets in the fog are small enough to penetrate the open guard cells of stomata. For example, the droplets may have a diameter of less than or equal to approximately 40 μm, or preferably less than or equal to approximately 30 μm, or preferably less than or equal to approximately 25 μm, or more preferably less than or equal to approximately 20 μm. The droplets may be as small as approximately 0.5 μm, or even approximately 0.1 μm. Thus, the droplets may have diameters in the range of approximately 0.1 μm to approximately 40 μm, or preferably from approximately 0.5 μm to approximately 30 μm. The fogging system 23 can provide a fog which creates high humidities in the aeroponic propagator 1 which allow stomata to open for gas exchange and nutrient contained in the fog droplets to easily penetrate the leaves and produce a uniquely strong foliar feed action.

The aeroponic propagator may comprise a further fogging system 25, as depicted in FIG. 4A. The further fogging system 25 is configured to promote sterilization in the aeroponic propagator 1. The further fogging system 25 is configured to supply a fog to at least part of the aeroponic propagator 1 and/or at least part of the plant 16. The aeroponic propagator 1 may comprise a reservoir 26 of liquid 27 for use by the further fogging system 25. Alternatively, the further fogging system 25 could use the same reservoir 10 with liquid 28 as used by the fogging system 23. The further fogging system 25 is configured to electrically charge the fog to promote sterilization of the at least part of the aeroponic propagator and/or at least part of the plant 16. The liquid 27 used by the further fogging system 25 may be water. The further fogging system 25 may be configured to supply droplets having a diameter of less than or equal to approximately 50 nm, or preferably less than or equal to approximately 25 nm.

The further fogging system 27 may comprise at least one electrically charged device 29 as depicted in FIG. 4A, which can be used to electrically charge the fog supplied by the further fogging system 25. The electrically charged device 29 may be any shape. The electrically charged device 29 may comprise at least one metal rod, metal rope, any conductive rod or rope, metal or carbon fibre strands, and/or a mesh. Links between conductive rods and/or ropes and fibres may be used to increase the available surface area of the electrically charged device 29 to more efficiently electrically charge the droplets of fog.

The use of a fog having small, electrically charged droplets can have a sterilizing effect. Thus, a surface or area of the aeroponic propagator 1 could be sterilized using the fog from the further fogging system 25. For example, this may be particularly useful between crop cycles. Additionally or alternatively, the produce, when detached or part of the plant 16 may be exposed to the electrically charged fog to promote sterilization of the produce.

The further fogging system 25 may only be used very rarely, for example for only 4-5 hours in the whole life cycle of one crop. Thus, it may be useful for the further fogging system 25 to be portable, and thus removable from the aeroponic propagator 1, such that it can be removed and used in multiple aeroponic propagators 1. Alternatively, it may be useful to provide a fogging system 23 as described above, which can be configured to be used in the same way as the further fogging system 25 for promoting sterilization for a short period. Thus, although the further fogging system 25 is shown as a separate from fogging system 23 in FIG. 4A, it will be understood that the fogging system 23 and the further fogging system 25 may be the same fogging system. In other words, the further fogging system 25 described above, could be the same as fogging system 23 already described.

Additionally or alternatively, a device 77 may be provided as depicted in FIG. 4A. The device 77 may be configured to provide dry gas in the aeroponic propagator 1 (i.e. blow dry gas into the aeroponic propagator 1) to promote detachment of produce from cultivated plants 16. The dry gas can have a drying action on the produce which brings down the moisture content of the produce to a level that the produce more easily detaches from the rest of the plant 16. Additionally or alternatively, the device 77 may be configured to provide dry gas in the aeroponic propagator 1 (i.e. blow dry gas into the aeroponic propagator 1) to reduce or prevent decay and/or germination of the produce after detachment. The dry gas can have a drying action on the produce. This can help promote the final stage of the process of seed/produce ripening and allow produce to be made dry enough so it can be stored over long periods whilst reducing or preventing the produce from decaying or germinating (e.g. when the produce is wheat grain) after it has detached from the plant 16. This is particularly beneficial if the moisture content of the produce is kept below a certain level. For example, e.g. in the case of wheat, it is particularly beneficial if the moisture content is kept to less than or equal to approximately 16%. Additionally or alternatively, the device 77 may be configured to provide dry gas in the aeroponic propagator 1 (i.e. blow dry gas into the aeroponic propagator 1) at the appropriate time to promote pollination of plants.

The dry gas may have a relative humidity of less than 30%, or more preferably less that 15%. The relative humidity of the dry gas may be controlled to achieve a desired dryness of the air and/or a desired humidity in the aeroponic propagator 1. The device 77 may be beneficial in drying out the plant and/or produce as desired as rapidly as possible. The use of the device 77 and the aeroponic propagator 1 allow this to occur even during adverse weather conditions, such as during monsoons and wet seasons. The dry gas may be dry air and the device may be configured to induce movement of air in the propagator 1 and/or the induction of fresh air to be moved around inside the aeroponic propagator 1. The device 77 may be used to provide the dry gas when the fogging system is switched off so as to reduce the humidity of the environment. The device 77 may be used to ventilate the foliage chamber 55 and/or the root chamber 14. The same or similar blowing machines may be used for blowing device 74 and device 77. In other words, the device 77 may dry out the environment within the aeroponic propagator 1, and possibly heat the environment. The device 77 may optionally be used to provide heated dry gas, for example, the device may optionally comprise a heater to heat the dry gas. Although a heater may be provided, it may be beneficial to avoid using a heater to reduce energy consumption and save costs.

In drying out the environment, the humidity of the environment will decrease. This in turn would dry out the produce in the aeroponic propagator 1, which would increase the likelihood that the produce detaches from the plant and this would promote the produce to drop from the plant 16. The device 77 may be more effective if providing heated dry gas and may optionally comprise any appropriate conventional heater. It can be beneficial to use the device 77 to reduce the humidity inside the produce, which may prevent it from going mouldy after having been detached but still within the aeroponic propagator 1. For example, when a crop, wheat or rice for example, is ready to harvest, the produce (e.g. grain) can be allowed to swell and in due course fall (either of its own accord, e.g. under the effect of gravity, or with the help of any of the systems described herein) to the surface/base of the relevant chamber (i.e. the foliage chamber 55 or the root chamber 14). The produce may roll or slide down to its lowest point for collecting, e.g. bagging. During this period, drying may be continued to prevent mould growth causing damage. This may be particularly beneficial for rice.

A slightly alternative example of the first embodiment depicted in FIGS. 4A, 4B and 4C is depicted in FIG. 5. The aeroponic propagator 1 depicted in FIG. 5 may be particularly useful when the produce is cultivated on the roots, rather than the foliage, for example, when growing potatoes. In FIGS. 4A, 4B and 4C, it is depicted that the produce is located in the foliage chamber 55, hence the specific arrangement of the surface 70 and collector 72 relative to the produce. In FIG. 5, the plants 16 are more likely to be plants wherein the produce is grown in the root chamber 14. In this embodiment, the surface 70 is provided in the root chamber 14. As depicted, in this example, the surface 70 is directly underneath the plant 16 such that falling produce would fall onto the surface 70. Thus the skilled person would understood that a surface 70 could be provided in the root chamber 14 and/or the foliage chamber 55 and the collector 72 may be provided somewhere that allows useful accumulation of the produce, whether this is inside the root chamber 14 and/or the foliage chamber 55, or outside of both of these chambers.

In either of the examples depicted in FIGS. 4A, 4B, 4C and 5, it will be understood that any one, or a variety, of the mechanisms described may be used alone or in combination with each other. Thus, mechanisms described in any of FIGS. 4A, 4B, 4C and 5 can be used in combination with the mechanisms shown and described in any of the other FIGS. 4A, 4B, 4C and 5, even if they are not depicted in the other Figures. For example, it will be understood that the vibration mechanism 73 shown in FIG. 4A can be used in FIGS. 4B and 4C, and this applies to the other devices. Additionally, the different systems and devices may be provided in different areas in relation to the aeroponic propagator 1. For example, the fogging system 23 may be provided outside either or both of the chambers but may be configured to supply fog to the root chamber 14 and/or foliage chamber 55, ideally to supply fog to the chamber containing the produce. The same applies to the vibration device 73, the blowing device 74, and the device 77. These systems and devices are shown in specific locations in the figures, but this is for the purpose of example only, and the devices may be located anywhere in or near the aeroponic propagator 1 where the devices can be used. For example, the blowing device 74 is shown near the apex of the foliage chamber 55 in FIG. 4A, but the blowing device could be located elsewhere, e.g. near or below the base of the aeroponic propagator 1 as long as the air is directed to the preferred area/chamber for use. Additionally, it is noted that all of these devices may be used with various different produce and that each device may have varying effectiveness.

A further example is depicted in FIGS. 6A and 6B. Although the other mechanisms described above are not depicted in these figures, it will be understood that the features shown in FIGS. 6A and 6B may be used in addition, or as an alternative to the devices described above. As depicted in FIG. 6A, the aeroponic propagator 1 may comprise a cutting mechanism 78 comprising at least one blade. The cutting mechanism 78 is a further example of a self-harvesting system. The cutting mechanism 78 may be an automatic system. The cutting mechanism 78 is configured to move the at least one blade relative to the cultivated plants 16 to detach a part of the plant (e.g. to trim the roots) and/or the produce from the cultivated plant 16. Thus, the detached part of the plant and/or the produce can fall under the effect of gravity.

The cutting mechanism 78 may be a lightweight system. The cutting mechanism may be electric root trimmers, which could optionally be connected to low voltage power lines which may be passed overhead. The low voltage power lines may be used for powering other components in the aeroponic propagator, for example, they could be used for powering artificial lighting to help the plants grow. The low voltage power lines may be configured to support adjustable sun blinds (not shown). The cutting mechanism 78 may be removable from the aeroponic propagator 1. Thus, the cutting mechanism 78 may be temporarily installed. The cutting mechanism 78 may be portable, and may optionally comprise a power supply such as a battery pack for easy removal and installation in the aeroponic propagator 1. Therefore, a user of the aeroponic propagator 1, e.g. a field worker, is able to carry at least part of the cutting mechanism 78 between nearby aeroponic propagators to ensure that the cutting mechanism 78 gets as much use as possible.

For example, as depicted in FIG. 6A, a first blade 75a may be provided. The first blade 75a may have a wheel 76 at a bottom of the first blade 75a allowing the first blade 75a to be easily moved along the length of the aeroponic propagator 1. The top of the first blade 75a as depicted in FIG. 6B may be attached to a track or guide allowing movement and guiding the first blade 75a. The cutting mechanism may comprise multiple wheels 76 and/or an alternative mode of movement other than a wheel may be provided, for example, the first blade 75a may be moved along a track or guide. The alternative mode of movement may comprise hooks, e.g. mountain climber hooks, being provided. The hooks may be passed over or around a cable or rod. This may be advantageous because it may be straight forward to implement and more reliable and means that the cutting mechanism 78 may be more easily moved in directions which are not in a horizontal plane. Any of these examples may be self-propelled, e.g. the wheels may be powered and may be configured to engage with a track so as to provide more control over cutter movement along the length of the aeroponic propagator 1. Any of these examples may be driven by a motor, and optionally, cables, pulleys and/or rods, to push and/or pull the blades along the length of the aeroponic propagator 1.

FIG. 6A depicts an outer blade, i.e. the second blade 75b and an inner blade, i.e. the first blade 75a. It is noted that one or the other or both may be provided. One of the blades may be moved such that is can be used as an outer blade then an inner blade, or vice versa. For example, the first blade 75a may be an inner blade provided to cut the roots from the plant 16 and the outer blade, the second blade 75B, may be provided to cut the foliage from the plant 16. The produce may be attached to the foliage or the root depending on the plants 16 being cultivated. Using a cutting mechanism 78 may be advantageous in that the harvest may be carried out quickly and efficiently at a desired time. Thus, it is not necessary to wait for produce to detach as may be necessary using other mechanisms. Additionally, the location of the blade(s) being used relative to the portion of the plant being cut may be positioned to reduce the amount of waste, for example, by cutting close to the edge of the produce. The cutting mechanism 78 may also make it easier to remove waste from the aeroponic propagator 1 after the produce has been harvested by cutting down the waste remaining in the aeroponic propagator 1. The cutting mechanism may comprise some sort of mechanical system for transporting the waste and/or produce or any other removed parts of the plant, for example a brush and/or a blowing device aimed at the waste to move the waste and/or produce or any other removed parts of the plant optionally, to a collector, for example, bags attached to the ends of the aeroponic propagator 1.

The blades are shown and described as though moving along the aeroponic structure 1. In these examples, the aeroponic propagator 1 may be considered as an elongated structure with a length, for example as depicted in FIG. 1. However, the cutting mechanism 78 may be configured differently such that the blades do not travel along the length of the aeroponic propagator 1. Instead, the blades may move up and down the aeroponic propagator. In an example the blades may move parallel to the surface supporting the plants, for example, sheet 13. The cutting mechanism 78 may be configured to have tracks, guides and/or wheels along the ends of each of the blades to provide this movement.

In particular, the cutting mechanism 78 may be provided in conjunction with the fogging system 23. The cutting mechanism 78 may be configured to cut or damage (i.e. break the outer layer of) at least part of the roots of the plants 16. It is known that certain chemicals and/or hormones, e.g. Ribonucleic acid (RNA) may be absorbed by the plant better if the roots are damaged or cut. Thus, providing the cutting mechanism 78 in conjunction with the fogging system 23 may have a particular advantage.

In accordance with the first embodiment, a method may be provided for collecting produce from cultivated plants, the method comprising collecting produce which has detached from the cultivated plants using a self-harvesting system. The method of collecting produce may use any of the above described systems or apparatus. Thus it is understood that the method may collect produce as described above (for example, using a self harvesting system comprising any of the above described devices, etc.)

In a second embodiment, an aeroponic propagator 1 is provided, the aeroponic propagator 1 being for the cultivation of plants 16 and comprising a plurality of sealed tubes 80. An example of the sealed tubes 80 is depicted in FIG. 7. FIG. 7 is an example of an aeroponic propagator 1 without an outer cover i.e. only the layer above/containing a root chamber 14 is shown and a foliage chamber 55 may optionally also be provided. The ground 71 is depicted for context only.

FIG. 7 depicts sealed tubes 80 (and shows sealed tubes on the other side of the aeroponic propagator 1 in dotted lines). Although only a few sealed tubes 80 are shown, this is for the purpose of explanation only, and any appropriate number may be provided.

In this embodiment, each sealed tube 80 contains seeds 81 to be grown in the aeroponic propagator 1. The sealed tubes 80 have a mechanism configured to selectively rupture at least one sealed tube 80 to expose the seeds 81, contained in the sealed tube 80. It is noted that selectively in this context may mean that each tube may be individually and separately ruptured. The seeds 81 being exposed means that the environment around the seeds 81 changes from being the environment in the sealed tubes 80, to the environment in the aeroponic propagator 1. For example, the sealed tubes 80 may be selectively ruptured to expose the seeds 81 to the environment in the foliage chamber 55. Thus, for example, the seeds may be exposed to humid air and/or fog as will be further described, which may be present in the foliage chamber. The exposed seeds 81 may be in contact with such an environment, which may be different from inside the sealed tubes 80, for example, may have a different humidity, or constitute different gases. Exposure of the seeds 81 should trigger the seed germination process. Each sealed tube 80 may be selectively ruptured to rupture the sealed tube 80 on both sides of the seed 81 in order to expose the seed 81 to the surrounding environment. In other words, the mechanism may be configured to selectively rupture at least one sealed tube 80 above and below the seed 81.

The sealed tubes 80 may be grouped in closely spaced rows, for example, as depicted in FIG. 7. The rows may be substantially parallel, but this is not necessary. The rows can be positioned relative to each other as desired to control the positioning of the seeds 81. This may allow close spacing of seeds 81 to be used for growing plants 16. The tubes may be any appropriate range of sizes and the size is not particularly limiting. The tubes may be, for example only, approximately 10 mm to 150 mm in width, or more likely in the range of 50 mm to 100 mm. Parallel groupings of tubes, for example, each tube of type A or type B and so on as depicted in FIG. 7 and as described below may contain seeds which are harvested at the same time, and these types of tubes could be a metre or more apart from other tubes of the same type depending on the number and size of the cultivated plants 16 when mature. Similarly, the distance between each seed within a particular seed tube may be selected depending on the number and size of the cultivated plants 16 when mature within that particular tube.

In an example, it may be beneficial to provide seeds in the sealed tubes 80 which correspond to crop rotations. For example, a first tube indicated by A in FIG. 7 may comprise a first type of seed. Each different category of tube (e.g. A, B, C and D etc.) may have a different type of seed, wherein the seeds in each tube of type A are the same as each other, and the seeds in each tube of type B are the same as each other and so on. Although A to D are used here, it is understood that any number of different varieties may be used. Each letter may denote a different type of seed in the sealed tube 80.

Additionally or alternatively, even if the seed in different category of tube e.g. A or B are the same, the different categories may indicate a set of tubes containing seeds which are to be grown at the same time as each other, i.e. different categories may be ruptured at different times. Thus, the different category of tube may indicate a different timing at which the seed should be exposed. For example the mechanism may be configured to rupture the sealed tubes 80 which are category A at one time. When the plants 16 which are cultivated from category A are near to harvest or have been harvested, it may be desirable to start growing seeds from category B. Thus, at this time, the mechanism may be configured to rupture the group of sealed tubes 80 in category B. In this way, the mechanism can be used to control the exposure of seeds 81 to grow produce from the cultivated plants 16 in an organised and easily harvestable manner. It is noted that each tube may be separately controlled from the others, thus, in the context of this example, there could be multiple categories and each category could be considered to relate to only a single sealed tube 80.

Providing such a mechanism as in the second embodiment can be particularly beneficial because the aeroponic propagator 1 may be used to cultivate plants over an extended period of time. For example, when the produce has been harvested from plants cultivated from seeds in category A, a second set of sealed tubes, for example, of the type of category B may be selected and the category B type tubes may be selectively ruptured. This may be continued with desired timings for each category of tubes 80 until all the sealed tubes 80 have been selectively ruptured and all the seeds 81 have been exposed.

It will be understood that the features of the first embodiment and the second embodiment may be combined. For example, seeds may be provided in sealed tubes 81 as in the second embodiment. However, once ruptured, plants 16 may be cultivated leading to the growth of produce which may be harvested using any of the self harvesting systems described in relation to the first embodiment. It may be particularly beneficial to use the self harvesting techniques described above in relation to the first embodiment with the sealed tubes 81 because it further automates the harvesting and increases the efficiency with which the produce can be collected in the aeroponic propagator 1. The combination of both the first and second embodiments may be used to provide a human intervention free system, or at least one in which the requirement for human intervention is reduced. Human input can be used however, to reduce costs if desired, for example, in the harvesting of produce.

In the second embodiment, each tube has at least one corresponding cord, and the cord can be used to selectively rupture the at least one tube. FIG. 8A depicts an example of the sealed tubes 80 enclosing the seeds 81. In this example, each sealed tube has two corresponding cords 82a, one on either side of the seed 81, to enclose the sealed tube 80 around the seed 81. The cord 82a may be used as depicted in FIG. 8C to separate the sealed tubes 80 from each other, thus to seal the sealed tubes 80. Furthermore, not only does the cord 82a provide separation between the sealed tubes 80, the cord may be used to selectively rupture the at least one tube as depicted in FIG. 8B. For example, the sealed tube may be formed by a film 83 which may be lifted along the sealed tube 80 in the direction of the arrows shown. As the film 83 is pulled in the direction of the arrows, the cord 82a may tear from the film 83 on either side of the seed 81. In this way, the cord 82a may rupture this sealed tube 81 on either side of the seed 81. As the sealed tube 80 is ruptured, the seed 81 is exposed. Although only one side of the film 83 the sealed tube 80 is shown to be ruptured, the other side of the film 83 (i.e. the bottom side) may be ruptured in a similar way.

A variation is depicted in FIGS. 9A and 9B. In this example, the cord 82 is provided along the film 83 of the sealed tube 80 which is not the dividing portion. The sealed tubes may be separated from each other using a divider 84. The divider 84 may be a physical division, e.g. threading, or a connection formed by heating of the film 83 to seal layers of film 83 to form the individual sealed tubes 80. In this example, the cord 82b may be pulled in the direction of the arrows to tear the film 83 along the length of the sealed tube 80. Thus, each sealed tube 80 may be selectively ruptured using the cord 82. As in the example depicted in FIGS. 8A, 8B and 8C, the seeds 81 may be exposed in this way. Similarly, a further cord may be provided along the bottom of the sealed tube 81 to rupture film 83 along the bottom of the sealed tube (not shown).

The film 83 of the sealed tube 80 may be a clear film which may be beneficial in that it allows the seeds to be inspected if necessary. For example, the film 83 may be polythene and may be weldable. For example, the film 83 may be a film produced by BPI (British Polythene International). Only a portion of the sealed tube 80 may be formed by a clear film, for example, it may be beneficial to make the upper portion of the sealed tube 80 clear to allow inspection. Additionally or alternatively, the sealed tube 80 may be formed using a material with low water vapour permeability, e.g. the types of material used in the food packaging industry, which prevent water vapour penetrating and causing decay of the food, such as crisp packets or fizzy drink plastic containers. The material may preferably be formed having a water vapour permeability of less than or equal to approximately 1 US perm (i.e. less than or equal to approximately 57 ng·s⁻¹·m⁻²·Pa⁻¹, i.e. equal to approximately 57 SI perm), or preferably less than or equal to 0.1 US perm. More preferably, the material may be formed having a water vapour permeability of less than or equal to approximately 0.03 US perm, which is approximately the permeability of a 0.1 mm polyethylene sheet.

In the second embodiment, the sealed tubes 80 may be provided by a layer which allows the seeds 81 to grow roots after they are germinated and as they are cultivated as plants 16. For example, a base layer 85 may be provided which comprises a film 87a. Film 87a may be any film that provides a gas barrier. For example, the film 87a may be nanocellulose, a PET (polyethylene terephthalate) film or BoPet (Biaxially-oriented polyethylene terephthalate) film. The base layer 85 may optionally comprise a netting 87b, for example a biodegradable plastic netting. The base layer 85 may be provided to support the seeds 81. The film 87a may be any appropriate film which may support the seeds 81 and substantially prevent gas from passing through it. An example includes films developed by Innventia. The netting 87b may further support the seeds 81 but may degrade over time as the plant 16 grows. The netting 87b is optional and may or may not be provided as part of the base layer 85. This base layer 85 allows the seed to germinate once the sealed tube 80 has been ruptured, stops the seed 81 from falling due to gravity but allows the developing roots of the plant to pass through the base layer 85.

In an embodiment, the aeroponic propagator may comprise a porous layer 86 positioned in at least one sealed tube, the porous layer being configured to hold at least one seed. It is beneficial that the seeds in seed strips are able to germinate and sprout as rapidly as possible when they are exposed. In order to help them do this, the seeds may be held on, or in, a porous layer. The base layer 85 of FIG. 8A may be replaced with the porous layer 86 as depicted in FIG. 10. The porous layer 86 may be used in addition to or as an alternative to the base layer depicted in FIGS. 8 and 9. The porous layer 86 may allow fog droplets and atmospheric gases (especially oxygen and water vapour) to penetrate it easily. Advantageously, the porous layer 86 may also be sterile, compressible, provide a certain amount of support/anchorage for the plant as it grows, biodegradable, readily available and cheap. The porous layer 86 may instead be referred to as a membrane, but it will be understood that the membrane may hold seeds and allow fog droplets and atmospheric gases to penetrate it easily as described.

The porous layer 86 may be formed using various media, natural and artificial, including for example dried moss, open weave fabrics, low density plastic foams, or any combination thereof, etc. Preferably, the porous layer 86 is formed using dead, dried roots of plants grown aeroponically which has been found to be particularly beneficial for the development/growth of seeds and plants 16. The porous layer 86 being formed using dead, dried roots of plants grown aeroponically has the added advantage that they may otherwise end up being composted along with other aeroponic system crop waste.

In order to form the porous layer 86 using dead, dry root media, the root media may be compressed to reduce the amount of space they occupy until the sealed tube 80 containing the porous layer 86 is ruptured. Some plant species have relatively springy roots, even when completely dry, these will need to be chopped up into manageable lengths and mixed with a glue, for example, a quick-dry biodegradable glue, such as latex. Using a glue means that the porous layer may stay as densely packed as possible until its sealed tube 80 is opened and the seeds are exposed.

The film 87a and/or the netting 87b as depicted in FIGS. 8 and 9 may optionally be provided in addition to the porous layer depicted in FIG. 10.

The sealed tubes 80 may be integral to a component of the aeroponic propagator 1 (e.g. formed as part of a component of the aeroponic propagator 1). For example, the sealed tubes 80 may be formed as part of sheet 13. The sealed tubes 80 may be fixed to a component of the aeroponic propagator 1 (i.e. attached, e.g. glued, to a component of the aeroponic propagator 1). For example, the sealed tubes may be on top of sheet 13. In this case, the sheet 13 may be permeable, or have holes to allow the roots of the plants 16 to grow into the root chamber 14. Alternatively, the sheet 13 described above may be formed as a net, optionally attached to the aeroponic propagator as depicted in FIGS. 1 and 2, and the sealed tubes 80 may be positioned on top of, possibly attached to the net. Instead of being fixed as described, the sealed tubes 80 may be removably fixed to the aeroponic propagator 1 (i.e. by a mechanism which allows the sealed tubes 80 to be attached and detached without causing irreparable damage, e.g. using Velcro). In this way, the sealed tubes could be attached to and removed from the sheet 13, the net as herein described or another component of the aeroponic propagator 1 without damaging the aeroponic propagator 1 and may be replaced with new sealed tube 80 as and when desired.

In the second embodiment, a fogging system 23 may optionally be provided as depicted in FIG. 11. The fogging system 23 may be the same as the fogging system 23 described above except for differences described below. The fogging system may use the same liquid to generate a fog as previously described, i.e. the fog may comprise at least one hormone and/or chemical as previously described. The fogging system 23 may be configured to supply a fog to at least one of the exposed seeds and/or at least part of a plant 16 in the aeroponic propagator i.e. after the seed has been exposed. The fog being provided to the seed and/or part of the plant (i.e. the root and/or foliage) when it has been exposed means that the fog is supplied after the tube has been ruptured. The fogging system 23 may be configured to supply a fog to at least one of the sealed tubes 80. As depicted in FIG. 11, the fogging system 23 may be located anywhere appropriate with respect to the aeroponic propagator 1 but may be in fluid communication with at least one of the sealed tubes 80 in order to provide fog to the sealed tube 80. Additionally or alternatively, any appropriate liquid e.g. water could be supplied to at least one of the sealed tubes 80.

Additionally or alternatively, the fogging system 23 may supply fog to the root chamber 14 and/or the foliage chamber 55. In particular, the fogging system 23 may be configured to supply fog to the chamber containing the desired produce of the plant. The fogging system 23 may be configured to provide fog to the chamber to which the seed is exposed when the sealed tube 80 is ruptured. The liquid 28 used by the fogging system 23 may be selected to enhance a growth of the plant 16 and/or promote detachment as described in the first embodiment. The fogging system 23 may be controlled and varied or described in relation to the first embodiment.

Although the second embodiment comprises a plurality of sealed tubes, the skilled person would understand that a single sealed tube may instead be provided. The single tube may be ruptured as described above and may have any or all of the other features described above.

In accordance with the second embodiment, a method may be provided for cultivating plants, the method comprising providing a plurality of sealed tubes, each tube containing seeds to be grown in an aeroponic propagator and selectively rupturing at least one tube to expose the seeds contained in the tube. The method of providing and selectively rupturing the plurality of sealed tubes may use any of the above described systems or apparatus. Thus it is understood that the method may provide and selectively rupture the plurality of sealed tubes as described above (for example, using a corresponding cord for each tube, etc.)

In any of the above embodiments comprising a fog, the fog may be allowed to travel passively e.g. by gravity or diffusion, and/or actively e.g. by a mechanical blower (such as the blowing device 74 described above in relation to FIGS. 4A and 5). Thus, any of the above embodiments and examples may comprise a mechanical blower. The mechanical blower may be used to control the speed of the fog and/or its direction and may be variable, i.e. the blower may be variable speed device. Ideally, the fog within the aeroponic propagator 1 will travel at a speed of approximately 1 m/s to 1.5 m/s, or preferably approximately 1.3 m/s. The fog being moved at this speed means that it is able to respond much more quickly to changing growth conditions than hydroponic systems can. The fog used in the foliage chamber 55 for example, is intended to disrupt the boundary layer of still or slow moving fogged air in contact with leaf surfaces in order to enhance leaf gas exchange processes. The fog used in the root chamber 14 for example, may be slower than in the leaf chambers to avoid chilling the roots and drying the surfaces of root hairs, which should always be kept either wet or moist—preferably the latter.

The liquid 28 used by the fogging system 23 in any of the above embodiments may be selected as desired. The liquid may comprise RNA. Furthermore, the liquid 28 may additionally or alternatively comprise nitrogen fixing bacteria and/or a chemical and/or hormone to promote detachment of produce from cultivated plants 16. The aeroponic propagator 1 may further comprise a reservoir 10 as described above to hold the liquid 28 for use by the droplet generator to generate droplets.

In any of the above embodiments, the roots of the harvested plants may be removed, especially for some types of crop. For certain types of crop, if the roots are left in place, then the roots could restrict the flow of air and/or fog to the roots of the next crop/cycle. Thus, the aeroponic propagator 1 may comprise a mechanism for removing the roots, e.g. by cutting them using the cutting mechanism 78. The removed roots can be composted, and optionally, the resulting liquid compost leachate can be recycled.

Plant growth promoting bacteria (PGPB) have become increasingly important in the agricultural production of certain crops. However, the commercialisation and utilisation of PGPB has been currently limited due to the fact that there have not been consistent responses in different host cultivars and at different field sites. Thus, the controlled delivery of PGPB to root systems in soil is not possible under field conditions. The aeroponic propagator 1 of any of the above embodiments or examples can be used to generate a fog which can be used to deliver nitrogen fixing bacteria (e.g. rhizobacteria) to plants which overcome that limitation. The use of plant growth-promoting bacteria in agriculture in general looks very promising, particularly when used in a fog generated by any of the aeroponic propagators 1 described above.

1. An aeroponic propagator for the cultivation of plants, the aeroponic propagator comprising:
a self-harvesting system for collecting produce from cultivated plants wherein the self-harvesting system is configured to collect produce that has detached from the cultivated plants.

2. The aeroponic propagator of claim 1, wherein the self-harvesting system is configured to promote detachment of produce from the cultivated plants.

3. The aeroponic propagator of claim 1, wherein the aeroponic propagator has a surface which is arranged beneath the cultivated plants.

4. The aeroponic propagator of claim 3, wherein the surface is at least one of the following:
a) inclined such that detached produce which falls on to the surface is encouraged to roll or slide down the incline;
b) a resilient surface configured to reduce or prevent damage caused to produce on impact with the surface;
c) configured to undulate to move produce along the surface; and/or
d) a base, which may optionally be situated above the ground, preferably approximately 40-50 cm above the ground.

5. (canceled)

6. The aeroponic propagator of claim 3, wherein the surface has an arc shape formed along the length of the surface, and optionally comprises a drainage outlet in the surface.

7. (canceled)

8. (canceled)

9. The aeroponic propagator of claim 1, further comprising a collector configured to receive produce detached from the cultivated plants.

10. The aeroponic propagator of claim 1, further comprising a structure on which the plants are grown, and wherein the self harvesting system comprises a vibration mechanism configured to detach produce from the cultivated plants.

11. The aeroponic propagator of claim 10, wherein the vibration mechanism is configured to shake the structure to promote detachment of produce from the cultivated plants, optionally wherein the vibration mechanism comprises an oscillating and/or reciprocating device, wherein the frequency of oscillation and/or reciprocation can be controlled to control vibration of the structure.

12. (canceled)

13. The aeroponic propagator of claim 10, further comprising a blowing device configured to blow gas onto the structure to promote detachment of produce from the cultivated plants, optionally wherein the blowing device is a variable speed device.

14. The aeroponic propagator of claim 1, further comprising a blowing device configured to blow gas onto the plant to promote detachment of produce from the cultivated plants, optionally wherein the blowing device is a variable speed device.

15. The aeroponic propagator of claim 1, further comprising a fogging system for supplying a fog to at least one seed and/or at least a part of a plant in the aeroponic propagator and a reservoir of liquid for use by the fogging system, wherein the liquid comprises a hormone and/or chemical to promote detachment of produce from cultivated plants.

16. The aeroponic propagator of claim 1, further comprising a fogging system for supplying a fog to at least part of the aeroponic propagator, and a reservoir of liquid for use by the fogging system, wherein the fogging system is configured to electrically charge the fog to promote sterilization of the at least part of the aeroponic propagator, optionally
wherein the fogging system is configured to supply droplets having a diameter of less than or equal to approximately 50 nm, or preferably less than or equal to approximately 25 nm.

17. (canceled)

18. The aeroponic propagator of claim 1, further comprising a cutting mechanism comprising at least one blade, wherein the cutting mechanism is configured to move the blade relative to the cultivated plants to detach a part of the plant and/or the produce from the cultivated plant.

19. The aeroponic propagator of claim 1, further comprising a device to blow dry gas into the aeroponic propagator to promote detachment of produce from cultivated plants, and/or to reduce or prevent decay and/or germination of the produce after detachment, and/or at an appropriate time to promote pollination of plants.

20. A method for collecting produce from cultivated plants, the method comprising collecting produce which has detached from the cultivated plants using a self-harvesting system.

21. An aeroponic propagator for the cultivation of plants, the aeroponic propagator comprising a plurality of sealed tubes, each tube containing seeds to be grown in the aeroponic propagator, wherein the sealed tubes have a mechanism configured to selectively rupture at least one tube to expose the seeds contained in the tube.

22. The aeroponic propagator of claim 21, wherein each tube has a corresponding cord, and the cord can be used to selectively rupture the at least one tube, and/or
wherein the tube is made from a material with low water vapour permeability.

23. The aeroponic propagator of claim 21, further comprising a fogging system for supplying a fog to at least one exposed seed and/or at least an exposed part of a plant in the aeroponic propagator, optionally wherein the fogging system is configured to supply fog to at least one of the sealed tubes.

24. (canceled)

25. (canceled)

26. The aeroponic propagator of claim 21, further comprising a porous layer positioned inside the sealed tube, the porous layer being configured to hold the seeds, optionally
wherein the porous layer is formed of dead, dried roots of aeroponically grown plants.

27. (canceled)

28. A method for cultivating plants comprising:
providing a plurality of sealed tubes, each tube containing seeds to be grown in an aeroponic propagator; and
selectively rupturing at least one tube to expose the seeds contained in the tube.
